(19) United States
(12) Patent Application Publication
(10) Pub. No.: US 2025/0391957 A1
(43) Pub. Date: Dec. 25, 2025

(54) SPRING PLATE PRESSURE-TOLERANT BATTERY MODULE

(71) Applicant: EaglePicher Technologies, LLC, Joplin, MO (US)

(72) Inventors: Kristopher John FRUTSCHY, Joplin, MO (US); Danielle HUGUENIN, Joplin, MO (US); Jinal PATEL, Joplin, MO (US); Kenneth M. CAVANAGH, Joplin, MO (US); Frank PUGLIA, Joplin, MO (US); Rob GITZENDANNER, Joplin, MO (US)

(21) Appl. No.: 19/246,588

(22) Filed: Jun. 23, 2025

Related U.S. Application Data
(60) Provisional application No. 63/662,899, filed on Jun. 21, 2024.

(51) Int. Cl. H01M 10/6568; H01M 10/613; H01M 10/647; H01M 10/6556; H01M 50/211; H01M 50/24; H01M 50/325

(52) U.S. Cl. CPC H01M 10/6568; H01M 10/613; H01M 10/647; H01M 10/6556; H01M 50/211; H01M 50/24; H01M 50/325

(57) ABSTRACT

Aspects of the present disclosure may include a battery system including a plurality of cells and a housing. The plurality of cells each include a pouch cell; first and second compression plates; and a spring plate including a plurality of channels configured to receive a flow of coolant therethrough. The housing includes a cavity configured to receive the plurality of cells and the coolant. The battery system is configured to withstand environmental applied pressures of at least 100 pounds per square inch (psi).

### CROSS-REFERENCE TO RELATED APPLICATIONS

This application claims the benefit of U.S. Provisional Patent Application No. 63/622,899, filed Jun. 21, 2024, and hereby incorporates by reference herein the contents this application.

### TECHNICAL FIELD

Aspects of the present disclosure relate to cooling structures for use between battery cells within a battery pack or a battery module.

### BACKGROUND

Electrochemical cells are used as power sources in various devices and applications. Such cells are utilized as battery packs for supplying power to, e.g., electronics, electric vehicles, land vehicles, aircraft and/or marine vessels. These cells are commonly used in packs in which multiple cells are packed in close proximity, in order to achieve high energy density and small size. Due to the closeness of the cells to one another, if a cell emits hot gases and materials (e.g., due to internal short, thermal runaway or other event), this release can cause damage to adjacent cells. It would be desirable to provide improved designs for cells or packs that provide protection from damage and prevent thermal runaway of a cell from damaging other cells and potentially causing a cascading failure.

Battery packs typically include layered stacks of battery cells in close proximity to one another. During operation, heat is generated by the battery cells. Conventionally, such battery packs rely on conductive cooling, in which heat travels from the outer edges of the battery cells to a heat sink. This heating can lead to temperature buildup near the centers of the individual battery cells, and result in even larger temperature buildup in the battery cells located toward the center of the battery pack due to poor heat transfer from the battery pack center to the edge. Further, the close proximity adjacent battery cells in the battery packs can cause a thermal runaway event in one particular pouch cell to spread to other cells.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

In some aspects, a battery system includes a plurality of cells, a spring plate, and a housing. Each of the cells includes a pouch cell and first and second compression plates. The spring plate is disposed between two respective compression plates of two adjacent cells. The spring plate includes a plurality of channels for coolant flow. The housing includes a cavity configured to receive the plurality of cells, the spring plate, and the coolant. The battery system is configured to withstand environmental applied pressures of at least 100 pounds per square inch (psi).

In some aspects, a battery system includes a plurality of cells and a housing. Each of the plurality of cells includes a pouch cell, first and second compression plates, and a spring plate including a plurality of channels configured to receive a flow of coolant therethrough. The housing includes a cavity configured to receive the plurality of cells and the coolant. Due to natural convection, the coolant passively circulates through the cavity and the plurality of channels of the spring plate without the use of a pump.

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects, and advantages thereof, will be best understood by reference to the following detailed description of illustrative aspects of the disclosure when read in conjunction with the accompanying drawings, wherein:

FIG. 1 illustrates an example battery pack in accordance with aspects of the disclosure.

FIG. 2 illustrates an example cell stack of the battery pack of FIG. 1 in accordance with aspects of the disclosure.

FIG. 3 illustrates an exploded view of the battery pack of FIG. 1 in accordance with aspects of the disclosure.

FIG. 4 illustrates an example cell assembly of the battery pack of FIG. 1 in accordance with aspects of the disclosure.

FIG. 5 illustrates an exploded view of the cell assembly of FIG. 4 in accordance with aspects of the disclosure.

FIG. 6 illustrates a schematic representation of a stack of cells of FIG. 4 in accordance with aspects of the disclosure.

FIG. 7 illustrates a plot of cell steady-state temperature rise vs. cell heat density during operation for the pouch cell of the cell of FIG. 4 and a battery cell of a conventional battery pack in accordance with aspects of the disclosure.

FIG. 8 illustrates a schematic representation of another stack of cells of FIG. 4 in accordance with aspects of the disclosure.

FIG. 9 illustrates a section view of the battery pack of FIG. 1 in a housing in accordance with aspects of the disclosure.

FIG. 10 illustrates a front view of another cell assembly that can be used with the battery pack of FIG. 1 in accordance with aspects of the disclosure.

FIG. 10A illustrates an exploded view of the cell assembly of FIG. 10 in accordance with aspects of the disclosure.

FIG. 11 illustrates another example battery pack in accordance with aspects of the disclosure.

FIG. 12 illustrates an exploded view of the battery pack of FIG. 11 in accordance with aspects of the disclosure.

FIG. 13 illustrates a perspective view of an example cell of the battery pack of FIG. 11 in accordance with aspects of the disclosure.

FIG. 14 illustrates an exploded view of the cell of FIG. 11 in accordance with aspects of the disclosure.

FIG. 15 illustrates a section view of the battery pack of FIG. 11 taken along lines 15-15 of FIG. 11.

FIG. 16 illustrates a section view of the battery pack of FIG. 11 taken along lines 16-16 of FIG. 11.

FIG. 17A illustrates a detail view of a pouch cell including an anode electrode tab having a corner radius in accordance with aspects of the disclosure.

FIG. 17B illustrates the von Mises stress experienced by the corner radius of the anode electrode tab of FIG. 17A.

FIG. 18A illustrates a detail view of a pouch cell including an anode electrode tab having a corner radius and a potting material in accordance with aspects of the disclosure.

FIG. 18B illustrates the von Mises stress experienced by the corner radius of the anode electrode tab of FIG. 17A.

FIG. 19A illustrates a detail view of a pouch cell including an anode electrode tab having a corner radius and a potting material combined with compression plates in accordance with aspects of the disclosure.

FIG. 19B illustrates the von Mises stress experienced by the corner radius of the anode electrode tab of FIG. 19A.

FIG. 20 illustrates a schematic representation of a housing for the battery pack of FIG. 1 or FIG. 11 in accordance with aspects of the disclosure.

FIG. 21 illustrates various groove patterns for inner walls of the housing of FIG. 20 in accordance with aspects of the disclosure.

### DETAILED DESCRIPTION

The following includes definitions of selected terms employed herein. The definitions include various examples and/or forms of components that fall within the scope of a term and that may be used for implementation. The examples are not intended to be limiting.

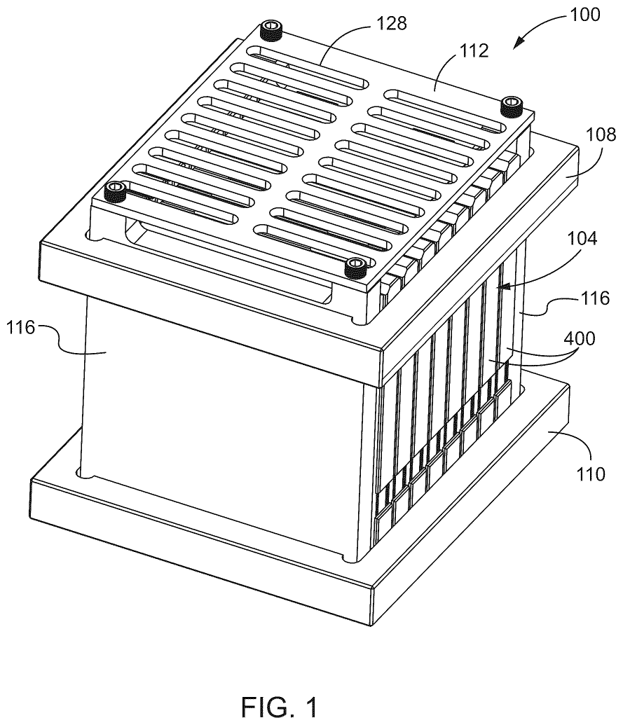

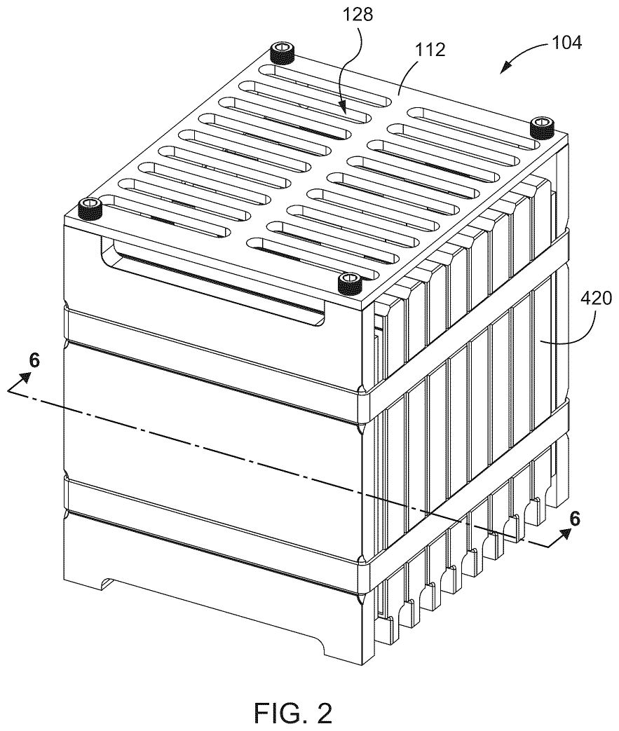

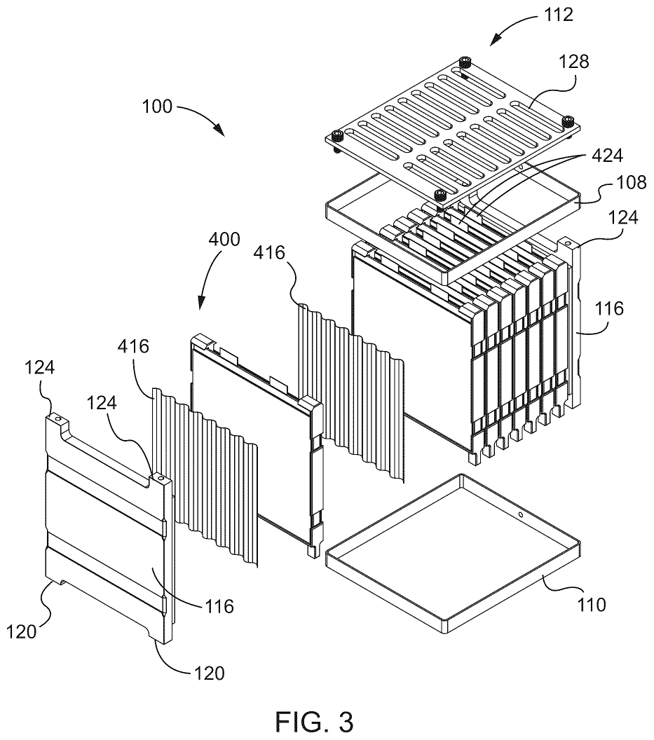

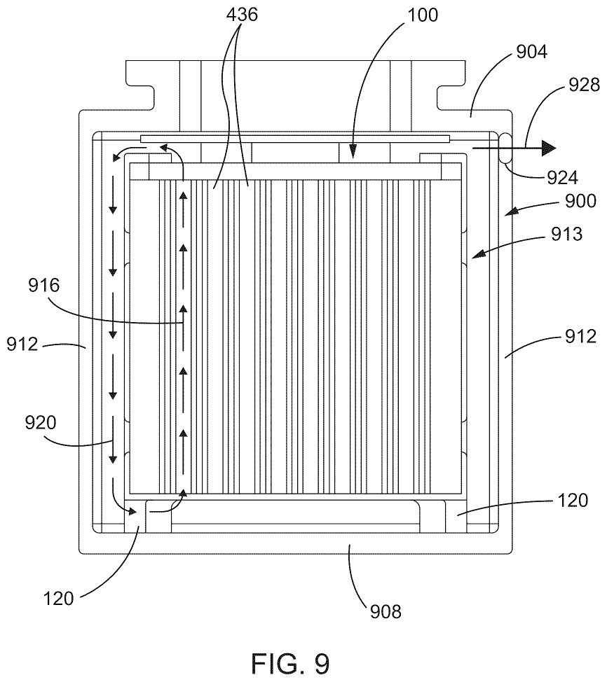

FIGS. 1-3 illustrate a battery pack 100 according to aspects of the present disclosure. The battery pack 100 includes a cell stack 104, a first or upper cell support frame 108, a second or lower cell support frame 110, a cover 112, and end plates 116. The cell stack 104 includes a plurality of cell assemblies 400. The end plates 116, the cell support frames 108, 110, and the spring plates 416 are configured to provide rigid support to the cell stack 104 and maintain the cell assemblies 400 in close proximity to each other. In an aspect, the end plates 116 and the cell support frames 108, 110 typically provide a compressive force on the cell stack 104. In some aspects, the end plates 116 include standoffs 124 (FIG. 3) configured to suspend the cover 112 above electrodes 424 of the pouch cells 404. In other aspects, the first cell support frame 108 may include the standoffs 124. The cover 112 includes a plurality of slots or holes 128 (FIG. 3). The holes 128 may be configured to receive wiring coupled to the electrodes 424 (FIG. 3) of the pouch cells 404. The holes 128 may also allow coolant to exit the battery pack 100. In some aspects, the end plates 116 include standoffs 120 configured to suspend the cell stack 104 above a bottom wall of the housing 900 (FIG. 9), such that coolant can flow beneath the cell assemblies 400 and through the channels 436. In other aspects, the standoffs 120 may be coupled to the second cell support frame 110. Throughout this disclosure, references to walls of the housing 900 (FIG. 9), such as the bottom wall, sidewalls, etc. refer to inner walls of the housing 900.

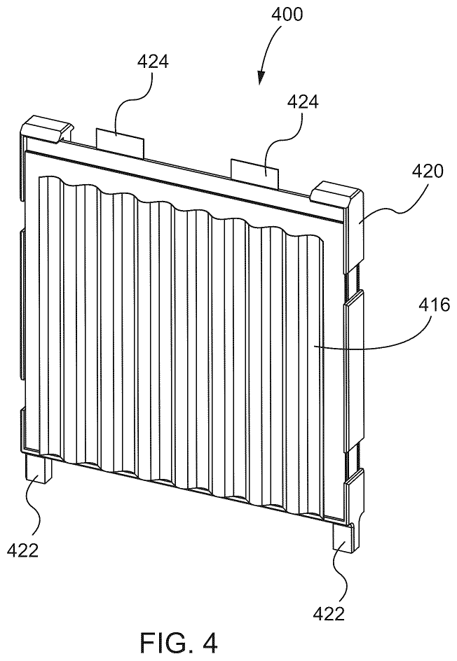

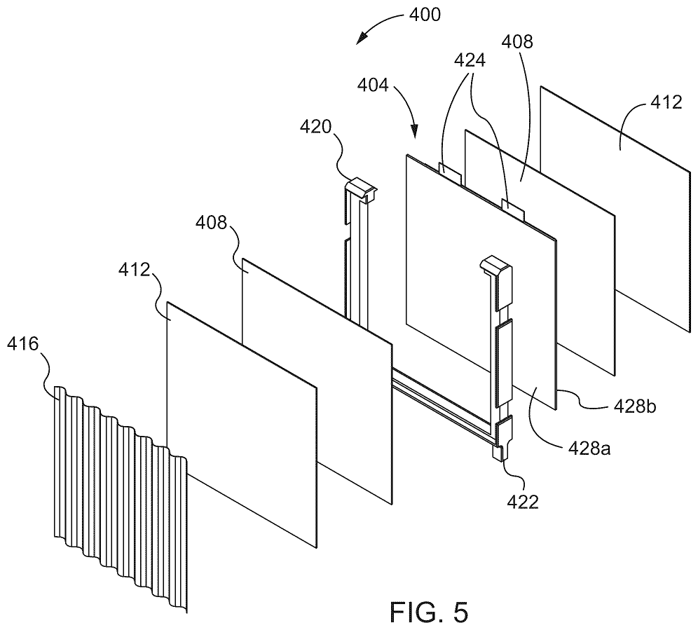

FIGS. 4-5 illustrate the cell assembly 400 according to aspects of the present disclosure. The cell assembly 400 includes a battery cell or pouch cell 404, insulators 408, compression plates 412, a spring plate 416, and a cell frame 420. In some aspects, presence and positioning of the components of the cell assembly 400 may vary. For example, insulators 408 may not be used in some aspects. In some aspects, the spring plate 416 may not be included as part of the cell assembly 400, but may instead be placed between some or all adjacent cell assemblies 400 in the cell stack 104. In some aspects, additional components may be included in the cell assembly 400 or the positioning of the pouch cell 404, insulators 408, compression plates 412, spring plate 416, and cell frame 420 may be varied from the aspect shown in FIGS. 4-5.

The pouch cell 404 includes electrodes 424 and first and second substantially planar faces 428a, 428b. In some aspects, the pouch cell 404 may include any rectangular cell, such as pouch cells (e.g., a rectangular electrode stack inside aluminized-polymer plastic bag enclosure) or prismatic cells (e.g., rectangular electrode stack inside rigid metal enclosure). Therefore, although the pouch cell 404 is interchangeably referred to herein as a pouch cell 404, the pouch cell 404 may also be a prismatic cell. In some aspects, the battery pack 100 may include an interconnect board configured to connect the pouch cells 404 in series or in parallel, as is known in the art.

The insulators 408 are configured for electrical and thermal insulation of the pouch cell 404. The insulators 408 may be or include material that is fully-dense and/or has small voids, such that the insulators will retain structural integrity (i.e., withstand) under high pressure. In some aspects, high pressure includes pressures of at least 100 psi. In some aspects, the high pressure includes pressures of at least 10,000 psi. In some aspects, the insulators 408 may be or include mica plates. In the aspects that include the insulators 408, the insulators 408 may be positioned adjacent to the pouch cell 404 (e.g., adjacent to each of the planar faces 428a, 428b of the pouch cell 404). In the illustrated aspect, the insulators 408 are substantially planar plates that overlie each of the planar faces 428a, 428b of the pouch cell 404. Mica is a fully-dense material, with good thermal insulation properties. Conventional thermal insulators used in conventional batteries are porous and would not work under high pressure conditions.

The compression plates 412 are configured to spread mechanical loads applied to the cell assembly 400, which may prevent the insulators 408 from being damaged by mechanical loads applied to the cell assembly 400. The compression plates 412 may also facilitate spreading of the heat generated by the pouch cell 404. In some aspects, the compression plates 412 may be or include a metal material, a plastic material, and/or a composite material that is fully-dense and/or has small voids, such that the compression plates 412 will retain structural integrity under high pressure. In some aspects, high pressure includes pressures of at least 100 psi. In some aspects, the high pressure includes pressures of at least 10,000 psi. In some aspects, the metal material includes aluminum and/or copper. In aspects that include the insulators 408, the compression plates 412 may be positioned adjacent to each of the insulators 408. In embodiments that do not include the insulators 408, the compression plates 412 may be positioned adjacent to the pouch cell 404 (e.g., adjacent to each of the planar faces 428a, 428b of the pouch cell 404). In the illustrated aspect, the compression plates 412 are substantially planar plates that overlie the insulators 408 and/or each of the planar faces 428a, 428b of the pouch cell 404.

The frame 420 is configured to align and support the pouch cell 404, the insulators 408, the compression plates 412, and the spring plate 416. In some aspects, the frame 420 may include a slot configured to receive the pouch cell 404. In some aspects, the insulators 408 and the compression plates are also received within the frame 420. The spring plate 416 may lie adjacent to the frame 420 or may engage with the frame 420. When positioned within the support frame 108, 110 the frames 420 provide a skeleton that is configured to support the cell stack 104. In some aspects, the frame 420 may include standoffs 422 configured to suspend the cell stack 104 above a bottom wall of the housing 900 (FIG. 9), such that coolant can flow beneath the cell assemblies 400 and through the channels 436.

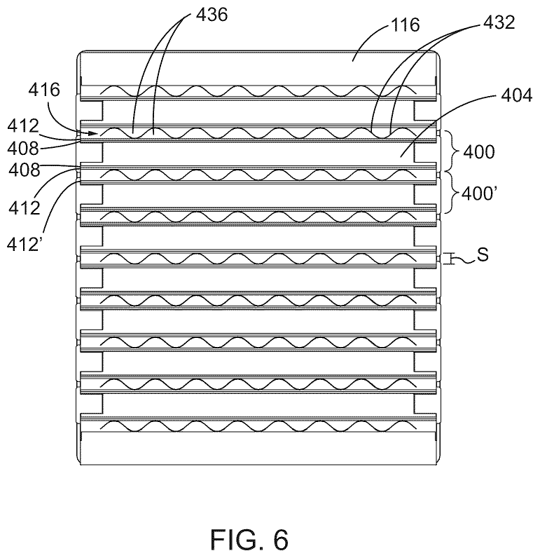

The spring plate 416 is a resilient plate that includes corrugations 432 (FIG. 6). The spring plate 416 overlies one of the compression plates 412. The spring plate 416 is configured to apply a continuous compressive force on the pouch cell 404 when the cell assembly 400 is loaded into the cell support frames 108, 110. In some aspects, the spring plate 416 is made from a material configured to provide compressive force of at least about 10 pounds per square inch (psi), at least about 30 psi, at least about 50 psi, and/or at least about 75 psi when the plurality of cell assemblies 400 is coupled to the cell support frames 108, 110 in the assembly of the battery pack 100. The material may be or include plastic, metal, and/or composite materials that provide an elastic force response to achieve the above-described compressive force and that will retain structural integrity under high pressure. In some aspects, high pressure includes pressures of at least 100 psi. In some aspects, the high pressure includes pressures of at least 10,000 psi. Such continuous compression may prevent inter-layer separation of the components of the pouch cells 404 and increase the life of the pouch cells 404. The spring plate 416 can deflect as the pouch cell 404 expands and retracts during operation. Further, the spring plate 416 is configured to form a spacing S between compression plates 412 of adjacent pouch cells 404. In some aspects, the spacing S (FIG. 6) is about 3 millimeters (mm). In some aspects, the spacing S is about 2 mm to about 6 mm. In a shipping configuration, in which coolant has not yet been added to the housing including the battery pack 100, the spacing S provides an air gap between adjacent pouch cells 404, which may thermally isolate adjacent pouch cells 404 from a pouch cell 404 that experiences a thermal runaway event during shipping. The spacing S and the resilience of the spring plate 416 can also accommodate bulging of a failed pouch cell. In an operational configuration, the corrugations 432 in the spring plate 416 are configured to form channels 436 (FIG. 6) through which coolant can flow.

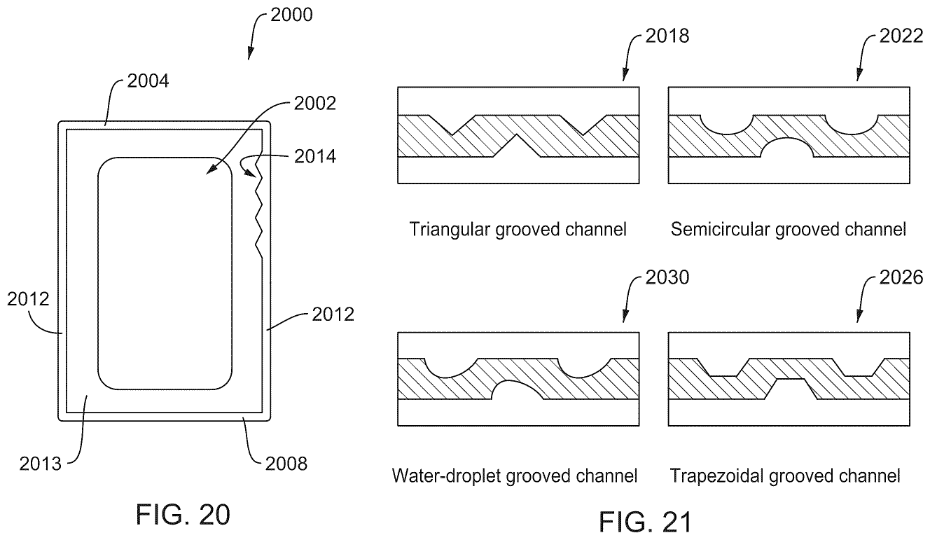

In the illustrated configuration, the corrugations 432 have a zig-zag shape when viewed in a direction orthogonal to the channels 436. In other configurations, the corrugations 432 may have other shapes, such as waveforms, triangular grooved channels 2018 (FIG. 21) semi-circular channels 2022 (FIG. 21), half-droplet-shaped channels 2030 (FIG. 21), trapezoid-shaped channels 2026 (FIG. 21) and so forth.

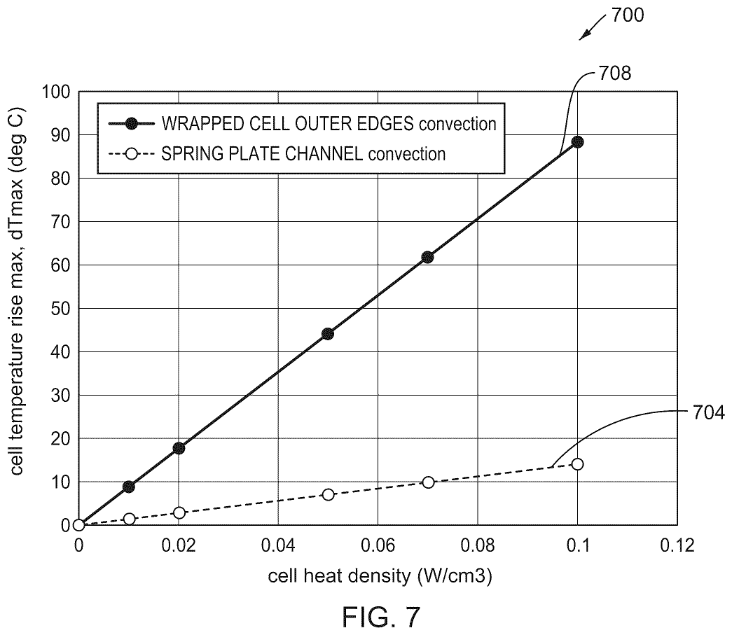

FIG. 6 illustrates a schematic representation of a stack of cell assemblies 400. As shown in FIG. 6, the spring plate 416 is positioned in the space S between compression plates 412, 412′ of adjacent cell assemblies 400, 400′. During operation of the battery pack 100, coolant flows through the channels 436 formed by the corrugations 432. Since the corrugations 432 and the channels 436 overlie the compression plates 412 (and therefore the planar faces 428a, 428b of the pouch cell 404), the coolant can absorb heat released from the planar faces 428a, 428b of the pouch cell 404 by convection. This configuration allows a majority of the surface area of the pouch cell 404 to be used for cooling. This configuration can result in improved cooling relative to conventional battery packs in which heat transfer from the battery cells occurs via the sidewalls, especially for pouch cells 404 in the middle of the battery pack 100. For example, FIG. 7 illustrates a plot of cell temperature rise vs. cell heat density during steady-state operation for the pouch cell 404 (line 704) of the battery pack 100 and a battery cell of a conventional battery pack (708). As shown in FIG. 7, the maximum temperature of the pouch cell 404 is about 80% lower than the temperature of the battery cell in the conventional battery pack.

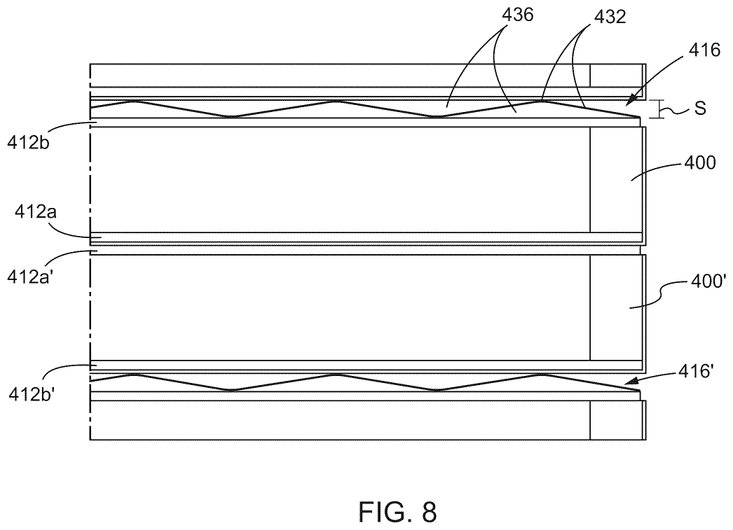

Referring again to FIG. 6, the cell assemblies 400 are oriented such that a spring plate 416 is positioned between compression plates 412, 412′ of adjacent cell assemblies 400. However, the cell assemblies 400 can also be arranged in other configurations. For example, FIG. 8 illustrates a configuration in which adjacent pouch cells 404, 404′ are arranged in pairs, in which one compression plate 412a, 412a′ of each pouch cell 404, 404′ is adjacent to a compression plate 412a, 412a′ of the adjacent pouch cell 404, 404′. The second compression plate 412b, 412b′ of each pouch cell 404, 404′ is adjacent to a spring plate 416, 416′. The configuration shown in FIG. 8 provides natural convection cooling to each pouch cell 404 inside the cell stack 104, but has reduced cell-to-cell spacing compared to FIG. 6, which increases the overall battery energy density and power density for the battery with FIG. 8 cell stack configuration.

FIG. 9 illustrates a section view of a battery system including the battery pack 100 in a housing 900 including a top wall 904, a bottom wall 908, and sidewalls 912 that define a cavity 913 configured to receive the battery pack 100 and coolant therein. The battery pack 100 may be positioned within the housing 900 such that the battery pack 100 is spaced from the walls 904, 908, 912 of the housing 900, for example by at least one 1 mm. In such aspects, the standoffs 120 suspend the battery pack 100 above the bottom wall 908 of the housing 900.

In the operational configuration, the housing 900 is filled with a coolant. In some aspects, the coolant is a dielectric fluid that provides sufficient electrical isolation between the cell assemblies 400 and the housing 900. Examples of such coolant may include Alpha-1 dielectric fluid, Alpha-2 dielectric fluid or mineral oil. Viscosity of the coolant should be low enough to allow for sufficient natural convection fluid flows, such as fluid velocity great than 0.1 mm/sec. In operation, the coolant circulates within the housing 900 and the channels 436. In the illustrated configuration, the coolant circulates passively due to natural convection, e.g., a pump is not used to circulate the coolant. In operation, the heat released by the pouch cells 404 warms the coolant, causing the density of the coolant in the channels 436 to decrease. This density decrease in turn causes the coolant to travel towards the top wall 904 of the housing due to the buoyancy force, until the coolant exits the channels 436, as shown by the arrows 916. After exiting the channels 436, the temperature of the coolant decreases, causing the density of the coolant to increase. This density increase causes the coolant to travel towards the bottom wall 908 of the housing, as shown by arrows 920. The disclosed aspects rely on passive cooling due to difficulties associated with running a pump for an active cooling system at high pressures. The high-pressure environment necessitates that system complexity and reliability risk should be minimized, which is achieved by the passive cooling realized by the disclosed spring plate aspects.

In some aspects, the housing 900 includes a check valve 924 configured to allow gasses released during a cell thermal runaway event of one or more pouch cells 404 to exit the housing 900 or to otherwise vent gases generated within the housing 900, as shown schematically by the arrow 928. This check valve 924 may prevent explosion of the housing 900 during such an event. Additionally, in the event of cell explosion, the channels 436 formed by the corrugations 432 of the spring plate 416 may direct the force of the explosion in a direction selected to minimize damage to other cells in the cell stack 104 or to the battery pack 100 as a whole. The check valve 924 may also prevent oxygen or other gases and fluids from entering into the battery housing 900. This blocking function reduces internal fire intensity in the event of an individual cell failure or multiple cell failures.

In some aspects, the battery pack 100 and the housing 900 are suitable for use under high pressure conditions. In such aspects, the materials of the battery pack 100 and the housing 900 are sufficiently dense and/or include small enough void sizes so as to not be crushed when operating in high pressure environmental conditions. As used herein, high pressure environmental conditions include pressures of at least 100 psi. In some aspects, the high pressure environmental conditions include pressures of at least 10,000 psi. Further, in such aspects, the housing 900 includes a flexible high thermal conductivity plastic material, which results in more efficient cooling and more uniform cell temperature. This conduction in turn allows a higher C-rate of charge/discharge of the pouch cells 404 and longer life of the pouch cells 404 by keeping cell temperature rise low. As used herein the phrase “high thermal conductivity” refers to thermal conductivities of at least 1 watt per meter-Kelvin (W/(m*K)). In some aspects, the material of the housing 900 has a ductility limit of at least 1% elongation. In some aspects, the housing 900 may include the COOLPOLY® D series of thermically conductive plastics produced by Celanese Corporation of Dallas, Texas.

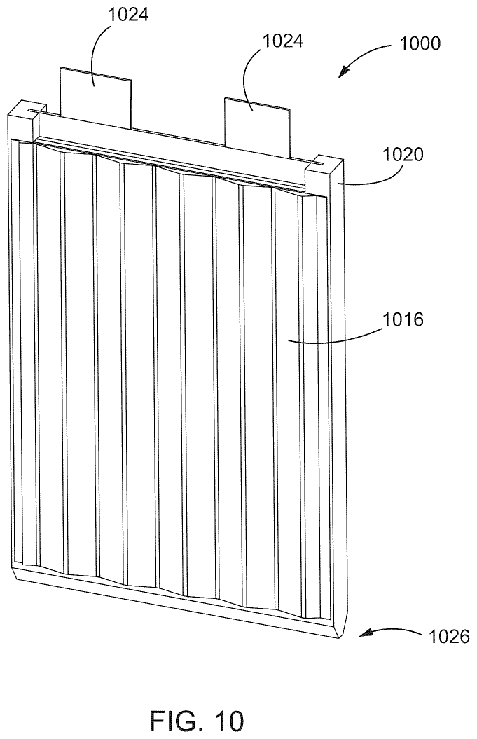

FIGS. 10-10A illustrate a cell assembly 1000 according to another aspect of the disclosure. In some aspects, a plurality of the cell assemblies 1000 can be incorporated into the battery pack 100 as described above with respect to the cell assemblies 400. Like numbering is used to indicate like parts between the cell assembly 1000 and the cell assembly 400. The cell assembly 1000 is only described in detail herein to the extent that it differs from the cell assembly 1000. The cell assembly 1000 may be positioned inside a housing similar to the housing 900.

As shown in FIGS. 10-10A, the frame 1020 does not include any standoffs. Instead, a bottom surface 1026 of the frame may be pointed, for example to suspend the cell assemblies 400 above a bottom wall of the housing 900 (FIG. 9), such that coolant can flow beneath the cell assemblies 400 and through the channels.

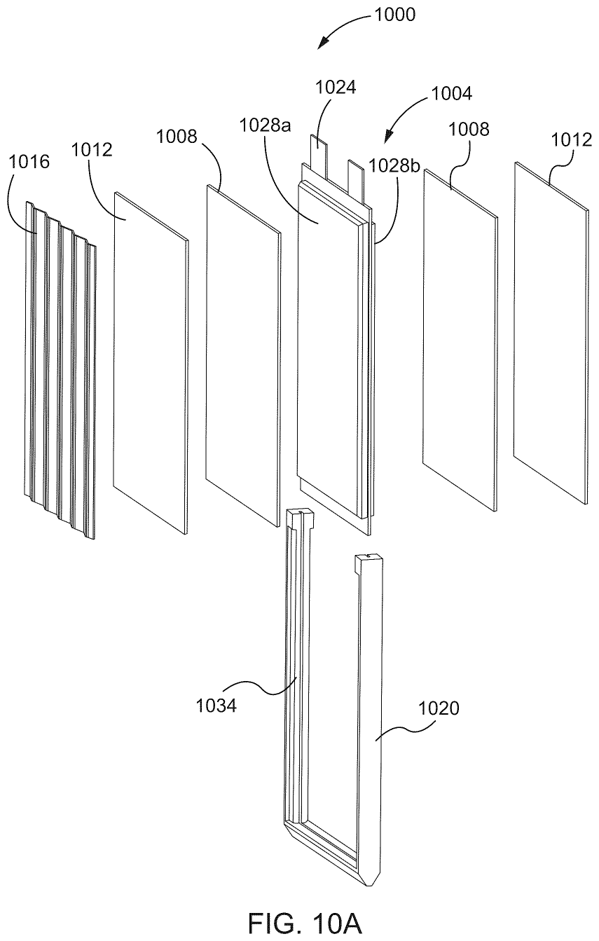

FIGS. 11-15 illustrate a battery pack 1100 and cell assembly 1300 according to aspects of the present disclosure. Like numbering is used to indicate like parts between the battery pack 1100 and the battery pack 100. The battery pack 1100 is only described in detail herein to the extent that it differs from the battery pack 100. Like numbering is used to indicate like parts between the cell assembly 1300 and the cell assembly 400. The cell assembly 1300 is only described in detail herein to the extent that it differs from the cell assembly 400.

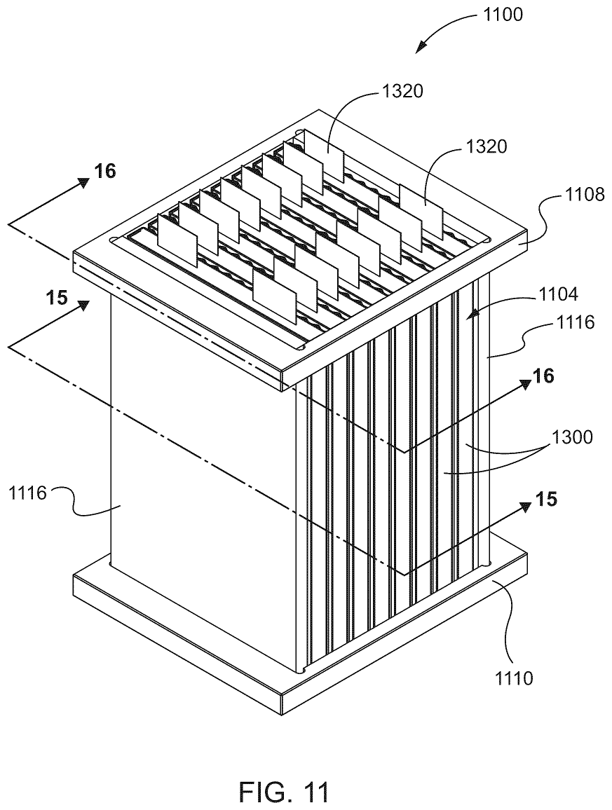

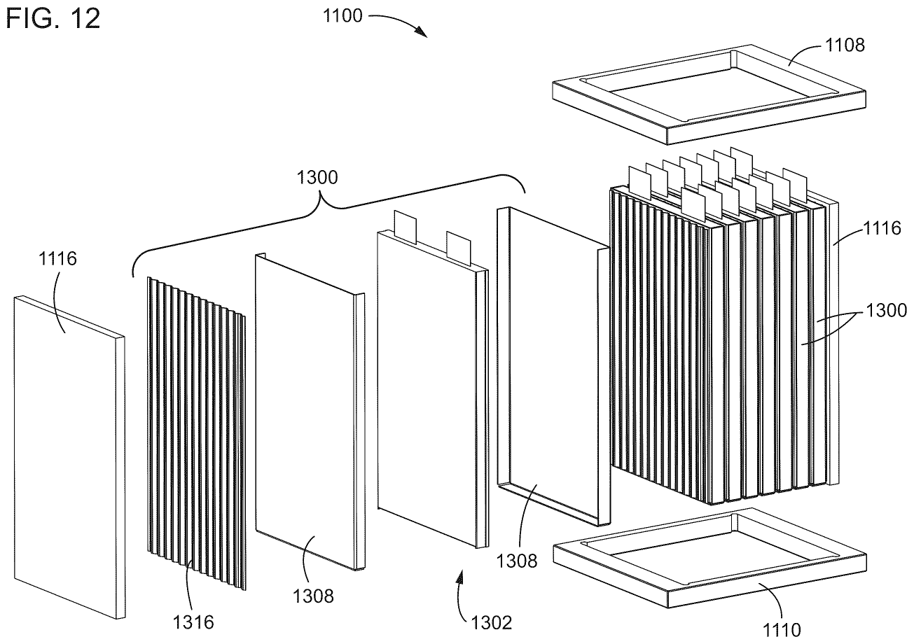

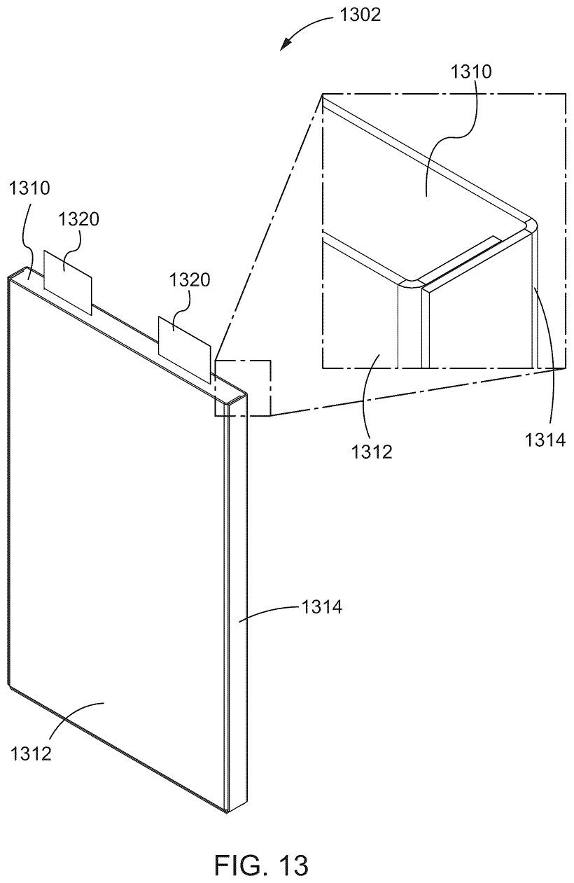

FIGS. 13-14 illustrate a cell sub-assembly 1302 according to an aspect of the disclosure. The cell sub-assembly 1302 can be incorporated into the cell assembly 1300, which in turn can be incorporated into the battery pack 1100. In such aspects, the spring plate 1316 may be positioned between adjacent cell assemblies 1300 or between adjacent pairs of cell assemblies 1300, similar to what is described above with regard to the cell assemblies 400. As shown in FIGS. 11-12, in some aspects, the spring plate 1316 may be positioned between groups of adjacent cell assemblies 1300, each group including two or more cell assemblies 1300. In aspects that include the insulators 1308, the insulators 1308 may be positioned adjacent to the cell sub-assembly 1302. In such aspects, the spring plate 1316 may be positioned adjacent to the insulators 1308.

As shown in FIGS. 13-14, the cell subassembly 1302 includes a pouch cell 1304, a potting material 1310, a first cover 1312, and a second cover 1314. The pouch cell 1304 includes electrodes 1320 and first and second substantially planar faces.

The covers 1312, 1314 are configured to spread mechanical loads applied to the cell assembly 1302. The covers 1312, 1314 may also facilitate spreading of the heat generated by the pouch cell 1304. In some aspects, the covers 1312, 1314 may be or include aluminum. In some aspects, the covers 1312, 1314 may be 0.25 mm to 2 mm thick. In some aspects the covers 1312, 1314 may be 0.5 mm thick. The first cover 1312 includes sidewalls 1328 and a bottom wall 1332. The second cover 1314 includes sidewalls 1336 and a bottom wall 1340. The first and second covers 1312, 1314 are dimensioned such that the sidewalls 1328 and the bottom wall 1332 of the first cover 1312 can be received within the sidewalls 1336 and bottom wall 1340 of the second cover 1314, thereby creating a cavity configured to receive the pouch cell 1304 therebetween. Once the pouch cell 1304 has been positioned within the cavity, liquid potting material is poured between the first and second covers 1312, 1314, filling the cavity.

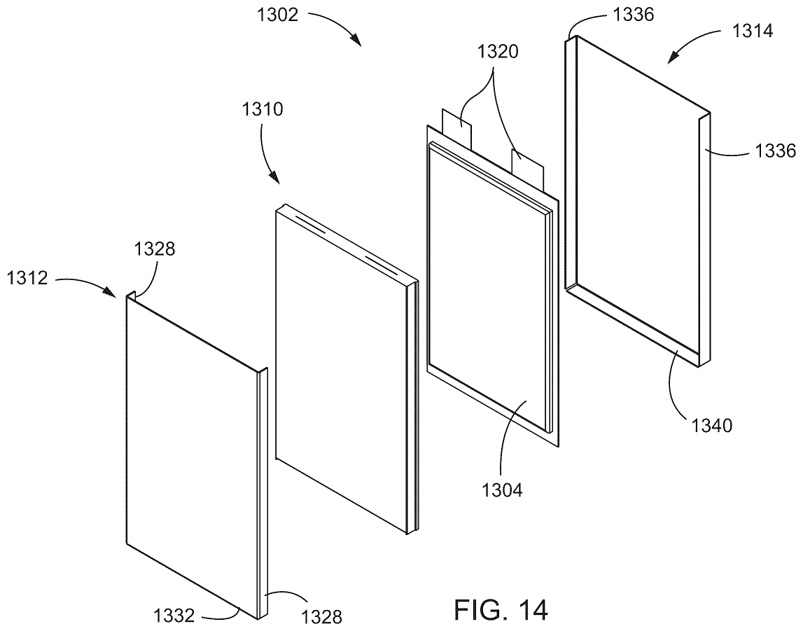

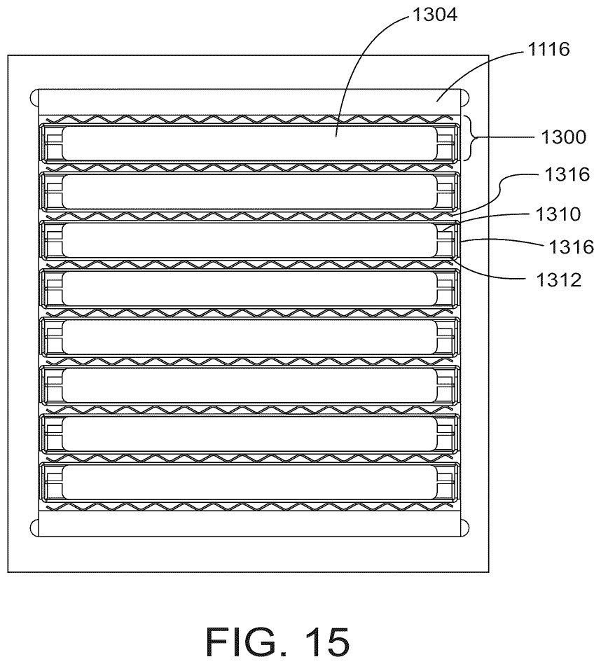

In some aspects, the potting material 1310 is an epoxy material such as uralite. The potting material 1310 is configured to provide mechanical support to the pouch cell 1304. For example, as shown in FIG. 15, which is a section view of the battery pack 1100 taken along lines 15-15 of FIG. 11, the potting material 1310 surrounds the pouch cell 1304. Further, as shown in FIG. 16, which is a section view of the battery pack 1100 taken along lines 16-16 of FIG. 11, the potting material 1310 extends over a portion of each of the electrodes 1320, providing support to the electrodes 1320. In some aspects, a thickness of the layer of potting material 1310 is about 1 mm to about 2 mm as measured from each of the two planar faces of the pouch cell. Including the potting material 1310 in each individual cell assembly 1000 rather than potting the entire battery pack is advantageous because less potting material (typically flammable) is present in the battery pack, resulting in a safer battery pack. In some aspects, the cell assembly 1000 may not include the covers 1312, 1314. In such aspects, the potting material 1310 is at least 2 mm thick.

The electrodes 1320 are made of a material, such as copper or aluminum, that is approximately 100 times stiffer than the other components of the pouch cell 1304. In conventional pouch cells, the electrodes 1320 are typically not supported by a potting material. Therefore, as the pouch cell undergoes cyclic hydrostatic pressure loading during operation, the electrodes experience the highest stresses relative to the other components of the pouch cell, which can lead to fatigue. In contrast, in the pouch cell 1304, the potting material 1310 surrounds the pouch cell 1304 and a portion of the electrodes 1320, which increases an effective stiffness of the pouch cell 1304. This reduces the stresses and fatigue experienced by the electrodes 1320 during cyclic hydrostatic pressure loading. For example, as shown in FIG. 16, which is a section view of the battery pack 1100, the potting material 1310 surrounds a portion of the electrodes 1320 that extends above the pouch cell 1304. In some aspects, the potting material 1310 increases the fatigue life of the electrodes 1320 during cyclic hydrostatic loading by about a factor of five. In some aspects, the potting material 1310 reduces the stress concentration at the electrode corner radius from about 2.6 to 1.0.

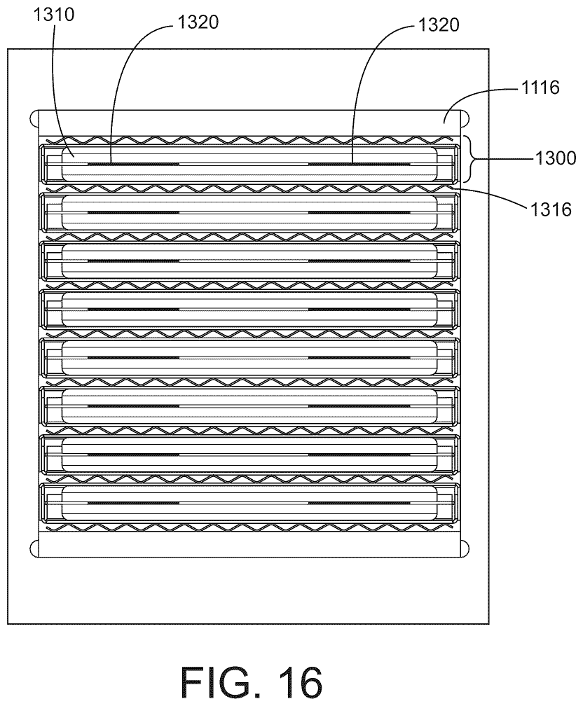

FIG. 17A illustrates a detail view of a pouch cell 1700 including an anode electrode tab 1704 having a corner radius 1708, which is a curved portion of the electrode tab 1704 proximate the top of the pouch cell 1700. In the configuration of FIG. 17A, a potting material does not surround the pouch cell 1700 or the anode electrode tab 1704. FIG. 17B illustrates the stresses experienced by the corner radius 1708 of the anode electrode tab 1704 during the application of 10,000 psi to the external surfaces of the pouch cell 1700. An average von Mises stress experienced by the corner radius 1708 is approximately 660 MPa.

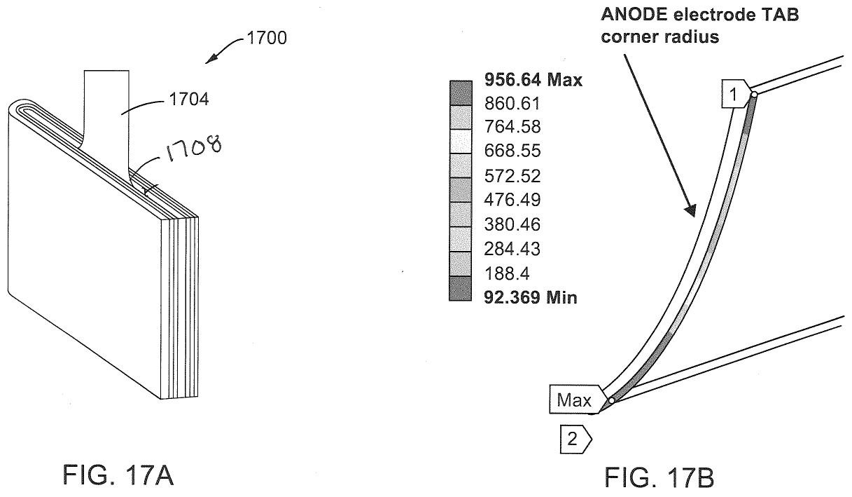

FIG. 18A illustrates a detail view of a pouch cell 1800 including an anode electrode tab 1804 having a corner radius 1808. In the configuration of FIG. 18A, a potting material 1812 having a thickness of approximately 2 mm surrounds the pouch cell 1800 and a portion of the anode electrode tab 1804 including the corner radius 1810. FIG. 18B illustrates the stresses experienced by the corner radius 1810 of the anode electrode tab 1804 during the application of 10,000 psi to the external surfaces of the pouch cell 1800. An average von Mises stress experienced by the corner radius 1808 is approximately 105 MPa, which is a 84% reduction in von Mises stress relative to the configuration of FIG. 17A.

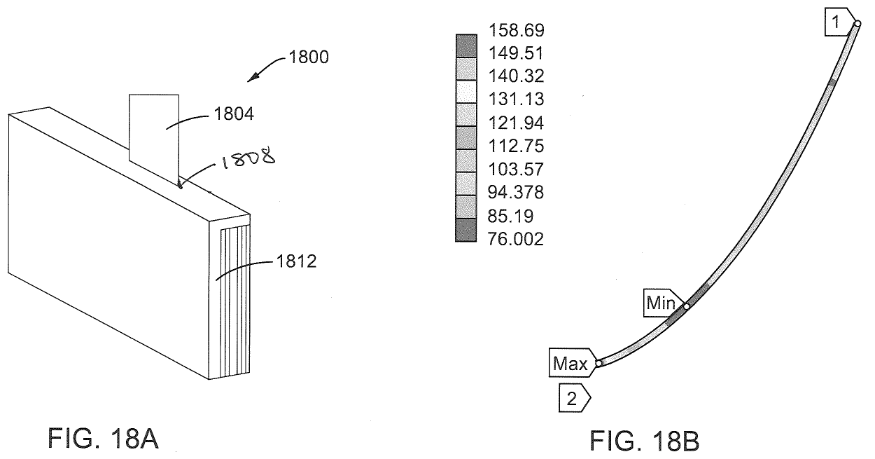

FIG. 19A illustrates a detail view of a pouch cell 1900 including an anode electrode tab 1904 having a corner radius 1908. In the configuration of FIG. 19A, a potting material 1912 having a thickness of approximately 1 mm surrounds the pouch cell 1900 and a portion of the anode electrode tab 1904 including the corner radius 1908. A 0.5 mm thick aluminum metal cover (not shown) surrounds the potting material 1912. FIG. 19B illustrates the stresses experienced by the corner radius 1908 of the anode electrode tab 1904 during the application of 10,000 psi to the external surfaces of the pouch cell 1900. An average von Mises stress experienced by the corner radius 1908 is approximately 120 MPa, which is a 82% reduction in von Mises stress relative to the configuration of FIG. 17A.

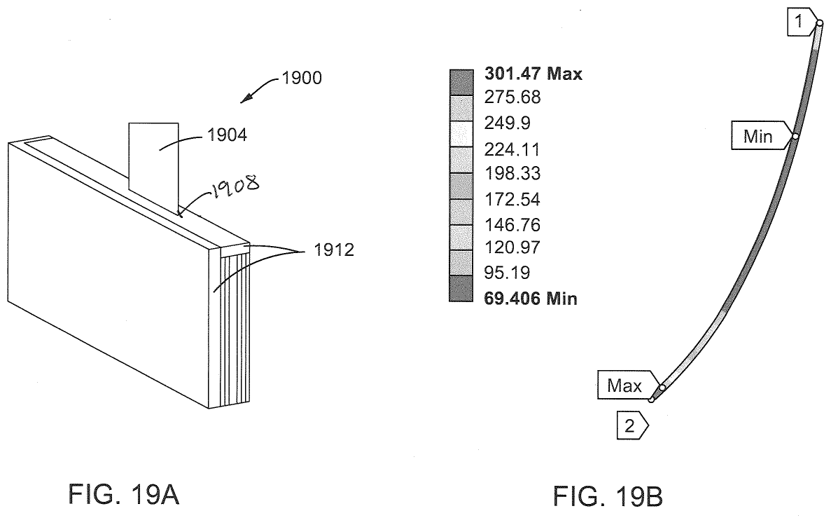

FIG. 20 illustrates a schematic representation of a housing 2000 for a battery pack 2002. The housing 2000 is substantially similar to the housing 900 described above and is only described to the extent that it differs from the housing 900. Like numbering is used to refer to like parts between the housing 2000 and the housing 900. The battery pack 2002 may be the same as the battery pack 100 or the battery pack 1100 and is not described in further detail herein.

The housing 2000 includes a top wall 2004, a bottom wall 2008, and sidewalls 2012. The battery pack 2002 is positioned within the housing 2000 such that the battery pack 2002 is spaced from the walls 2004, 2008, 2012 of the housing 2000 such that coolant can flow around and through the battery pack 2002.

As shown in FIG. 20, at least a portion of the inner surfaces of the walls 2004, 2008, 2012 include a pattern of grooves or channels 2014 configured to facilitate heat exchange. In some aspects, the channels 2014 may be included on the inner surfaces of the walls that experience the highest fluid velocity, such as, for example, the sidewalls 2012. FIG. 21 illustrates various patterns that can be used as the pattern 2014. In the aspect illustrated in FIG. 20, the texture 2014 includes triangular or zig-zag grooves 2018. In other aspects, the texture 2014 can include semi-circular grooves 2022, half-droplet-shaped grooves 2030, and/or trapezoid-shaped grooves 2026.

It will be appreciated that various implementations of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

What is claimed is:

1. A battery system comprising:
a plurality of cells, each of the cells including:
a pouch cell; and
first and second compression plates;
a spring plate disposed between two respective compression plates of two adjacent cells, the spring plate including a plurality of channels for coolant flow; and
a housing including a cavity configured to receive the plurality of cells, the spring plate, and the coolant;
wherein the battery system is configured to withstand environmental applied pressures of at least 100 pounds per square inch (psi).

2. The battery system of claim 1, wherein the spring plate is configured to form a spacing of at least 2 mm between the spring plate and a first compression plate of an adjacent cell in the plurality of cells.

3. The battery system of claim 1, wherein a shape of the plurality of channels of the spring plate includes a zig-zag, a waveform, a semi-circle, a half-droplet, or a trapezoidal shape, or a combination thereof.

4. The battery system of claim 1, wherein the pouch cell is positioned within a cavity formed between the first compression plate and the second compression plate, and wherein the housing is filled with a potting material that extends over at least a portion of electrodes of the pouch cell.

5. The battery system of claim 1, wherein the housing includes a flexible high thermal conductivity plastic material.

6. The battery system of claim 1, wherein the housing includes a check valve configured to vent gases generated within the housing.

7. The battery system of claim 1, wherein, in operation, the coolant circulates through the cavity and the plurality of channels of the spring plate without the use of a pump.

8. The battery system of claim 1, wherein at least one inner wall of the housing includes a pattern configured to facilitate heat transfer.

9. The battery system of claim 8, wherein the pattern includes one or more of zig-zag grooves, semi-circular grooves, half droplet-shaped grooves, trapezoid-shaped grooves, or a combination thereof.

10. The battery system of claim 1, wherein the housing includes a check valve configured to prevent oxygen or other gases or fluids from entering into the battery system.

11. A battery system comprising:
a plurality of cells, each of the cells including:
a pouch cell;
first and second compression plates; and
a spring plate including a plurality of channels configured to receive a flow of coolant therethrough; and
a housing including a cavity configured to receive the plurality of cells and the coolant;
wherein the coolant passively circulates through the cavity and the plurality of channels of the spring plate without the use of a pump.

12. The battery system of claim 11, wherein the spring plate is configured to form a spacing of at least 2 mm between the spring plate and a first compression plate of an adjacent cell in the plurality of cells.

13. The battery system of claim 11, wherein a shape of the plurality of channels of the spring plate includes a zig-zag, a waveform, a semi-circle, a half-droplet, or a trapezoidal shape, or a combination thereof.

14. The battery system of claim 11, wherein the pouch cell is positioned within a cavity formed between the first and second compression plates, and wherein the housing is filled with a potting material that extends over at least a portion of electrodes of the pouch cell.

15. The battery system of claim 11, wherein the housing includes a flexible high thermal conductivity plastic material.

16. The battery system of claim 11, wherein the housing includes a check valve configured to vent gases generated within the housing.

17. The battery system of claim 11, wherein the battery system is configured to withstand environmental applied pressures of at least 10,000 pounds per square inch (psi).

18. The battery system of claim 11, wherein at least one inner wall of the housing includes a pattern configured to facilitate heat transfer.

19. The battery system of claim 18, wherein the pattern includes one or more of zig-zag grooves, semi-circular grooves, half droplet-shaped grooves, trapezoid-shaped grooves, or a combination thereof.
